(19) United States
(12) Patent Application Publication
(10) Pub. No.: US 2026/0110303 A1
(43) Pub. Date: Apr. 23, 2026

(54) TURBO PUMP SYSTEM

(71) Applicant: KOREA AEROSPACE RESEARCH INSTITUTE, Daejeon (KR)

(72) Inventors: Soon Sam HONG, Daejeon (KR); Dae Jin KIM, Daejeon (KR)

(21) Appl. No.: 19/348,436

(22) Filed: Oct. 2, 2025

(30) Foreign Application Priority Data
Oct. 18, 2024 (KR) 10-2024-0142997

(51) Int. Cl. F04D 13/12; F04D 27/00; F04D 29/046; F04D 29/42; F04D 29/58

(52) U.S. Cl. CPC F04D 13/12; F04D 27/008; F04D 29/046; F04D 29/42; F04D 29/58

(57) ABSTRACT

A turbo pump system according to an embodiment may include a main pump having a discharge port and a suction port through which a fluid enters and exits, a branch pipe configured to discharge a part of the fluid, which is introduced from the suction port, through an outlet provided separately from the discharge port, and a booster disposed at an upstream side of the suction port and having an outlet communicating with the suction port, the booster being configured to raise pressure in the suction port, in which the fluid discharged through the branch pipe is introduced into the booster, operates the booster, and then moves to the suction port of the main pump.

### CROSS-REFERENCE TO RELATED APPLICATIONS

This application claims benefit and priority to Korean Patent Application No. 10-2024-0142997, filed on Oct. 18, 2024, with the Korean Intellectual Property Office, the disclosure of which is incorporated herein in its entirety by reference.

### TECHNICAL FIELD

Disclosed in a turbo pump system.

### BACKGROUND

A turbo pump refers to a device made by coupling a pump and a turbine configured to rotate at a high speed. The turbo pump is mainly used to transfer a high-pressure liquid or gas in aerospace, energy, precision machinery, and chemical processes. The turbo pump pumps a fluid by using the turbine that rotates at a high speed and plays an essential role in supplying fuel and oxidant at high pressure, particularly in a rocket engine. The system is highly advantageous in an environment that requires a high output and efficiency.

The turbo pump broadly includes the turbine and the pump. The turbine is operated by an external energy source (mainly, combustion gas), and a rotational motion of the turbine is converted into a rotational motion of the pump to transfer the fluid at a high speed. This structure enables high-output compression and transfer, and the turbo pump provides much higher performance than a traditional mechanical pump.

Research has been continuously conducted to improve the structural stability and efficiency of the turbo pump and simplify the process of manufacturing the turbo pump.

The above-mentioned background art is technical information that the inventors have retained to derive the present disclosure or have obtained in the course of deriving the present disclosure, and cannot be thus said to be technical information publicly known to the public before filing the present application.

### DOCUMENT OF RELATED ART

### Patent Document

(Patent Document 1) Korean Patent No. 10-1894781 entitled “TURBO PUMP AND LIQUID ROCKET ENGINE INCLUDING THE SAME”.

### SUMMARY

The present disclosure has been made in an effort to provide a turbo pump system capable of reducing energy waste and improving performance of a turbo pump by efficiently reusing a fluid that still maintains high pressure even after a bearing is cooled.

The present disclosure has also been made in an effort to provide a turbo pump system capable of maximally and efficiently utilizing a fluid by introducing the fluid, which has passed through a bearing, into a booster, operating the booster, and then guiding the fluid back into a suction port of a main pump.

Technical problems to be solved by the embodiments are not limited to the aforementioned technical problem, and other technical problems, which are not mentioned above, may be clearly understood by those skilled in the art from the following descriptions.

In order to achieve the above-mentioned objects, an embodiment of the present disclosure provides a turbo pump system including: a main pump having a discharge port and a suction port through which a fluid enters and exits; a branch pipe configured to discharge a part of the fluid, which is introduced from the suction port, through an outlet provided separately from the discharge port; and a booster disposed at an upstream side of the suction port and having an outlet communicating with the suction port, the booster being configured to raise pressure in the suction port, in which the fluid discharged through the branch pipe is introduced into the booster, operates the booster, and then moves to the suction port of the main pump.

According to the embodiment, the turbo pump system may further include: a bearing disposed between the main pump and the booster, in which the fluid moving through the branch pipe cools the bearing while passing through the bearing and then is introduced into the booster.

According to the embodiment, the booster may include: a turbine; and a turbine pump connected to the turbine, and the fluid may operate the turbine, rotate the turbine pump, and then raise pressure of the fluid passing through the booster.

According to the embodiment, the booster may include a nozzle having an injection port disposed toward the suction port, and the nozzle may inject the fluid into the suction port to raise the pressure in the suction port.

According to the embodiment, the turbo pump system may further include: a first flow path configured to connect the branch pipe and the booster, in which the fluid, which has been used to cool the bearing, is supplied to the booster through the first flow path.

According to the embodiment, the turbo pump system may further include: a second flow path configured to connect the discharge port of the main pump and the booster, in which the second flow path additionally supplies the fluid to the booster independently of the first flow path.

According to the embodiment, the turbo pump system may further include: a valve installed in the second flow path and configured to switch to a first mode or a second mode, in which the valve selectively allows a flow of the fluid flowing through the second flow path.

According to the embodiment, a movement of the fluid through the second flow path may be allowed when the valve switches to the first mode, and a movement of the fluid through the second flow path may be interrupted when the valve switches to the second mode.

According to the embodiment, the turbo pump system may further include: a controller configured to control the valve, in which the controller remotely switches the valve to the first mode or the second mode.

According to the embodiment, the booster may include: a turbine; and a turbine pump connected to the turbine, the booster may further include: a fluid supplier configured to supply the fluid to the turbine pump; and a sensor configured to measure a value of internal pressure of the fluid supplier, and the controller may compare a reference pressure value, which is inputted in advance, and the value of the internal pressure of the fluid supplier and control the valve.

According to the embodiment, the controller may control the valve to switch the valve to the first mode when the value of the internal pressure of the fluid supplier is smaller than the reference pressure value.

According to the turbo pump system according to the embodiment, it is possible to reduce energy waste and improve the performance of the turbo pump by efficiently reusing the fluid that still maintains high pressure even after the bearing is cooled.

According to the turbo pump system according to the embodiment, it is possible to maximally and efficiently utilize the fluid by introducing the fluid, which has passed through the bearing, into the booster, operating the booster, and then guiding the fluid back into the suction port of the main pump.

The effects of the turbo pump system according to the embodiment are not limited to the aforementioned effects, and other effects, which are not mentioned above, may be clearly understood by those skilled in the art from the following descriptions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view schematically illustrating a turbo pump system according to an embodiment.

FIG. 2 is a view schematically illustrating the turbo pump system according to the embodiment that includes a booster including a turbine and a turbine pump.

FIG. 3 is a view schematically illustrating the turbo pump system according to the embodiment that includes the booster including a nozzle.

FIG. 4 is a view schematically illustrating the turbo pump system according to the embodiment in FIG. 2 that has a second flow path.

FIG. 5 is a view schematically illustrating the turbo pump system according to the embodiment in FIG. 3 that has the second flow path.

The following drawings attached to the present specification illustrate exemplary embodiments of the present disclosure and serve to further understand the technical spirit of the present disclosure together with the detailed description of the present disclosure, and the present disclosure should not be interpreted as being limited to the items illustrated in the drawings.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, embodiments will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments, a detailed description of publicly known configurations or functions incorporated herein will be omitted when it is determined that the detailed description obscures the subject matters of the embodiments.

In addition, the terms first, second, A, B, (a), and (b) may be used to describe constituent elements of the embodiments. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The constituent element, which has the same common function as the constituent element included in any one embodiment, will be described by using the same name in other embodiments. Unless disclosed to the contrary, the configuration disclosed in any one embodiment may be applied to other embodiments, and the specific description of the repeated configuration will be omitted.

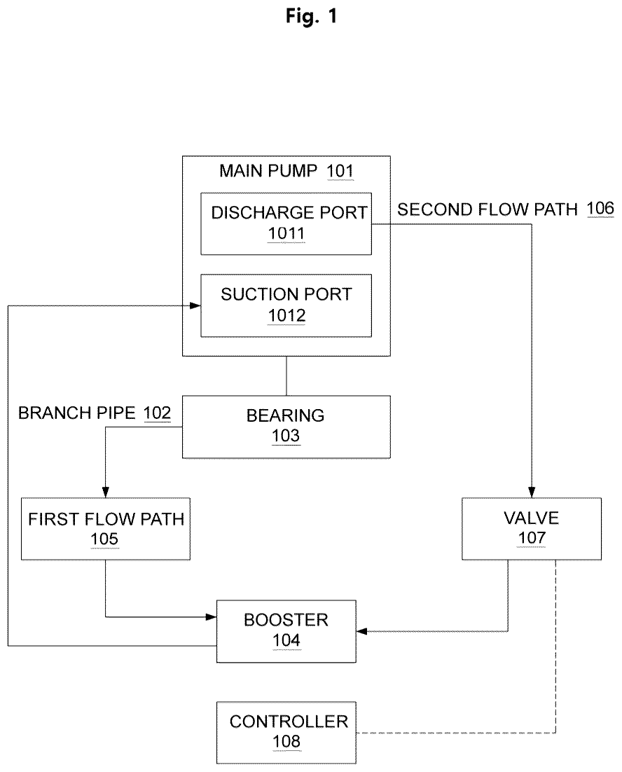

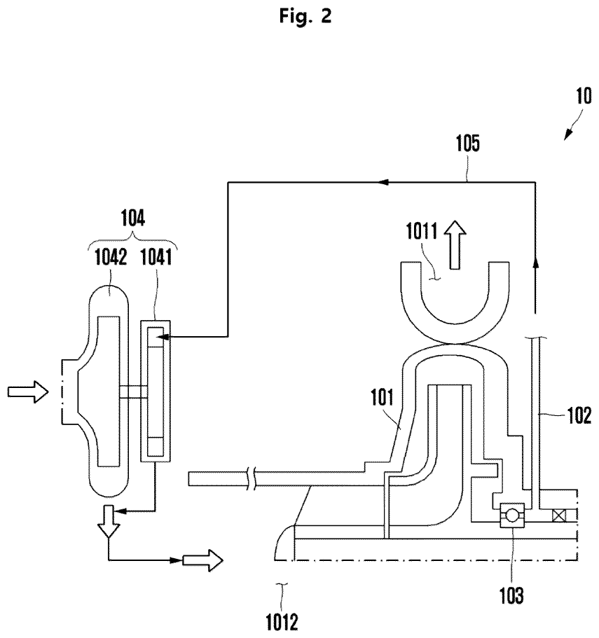

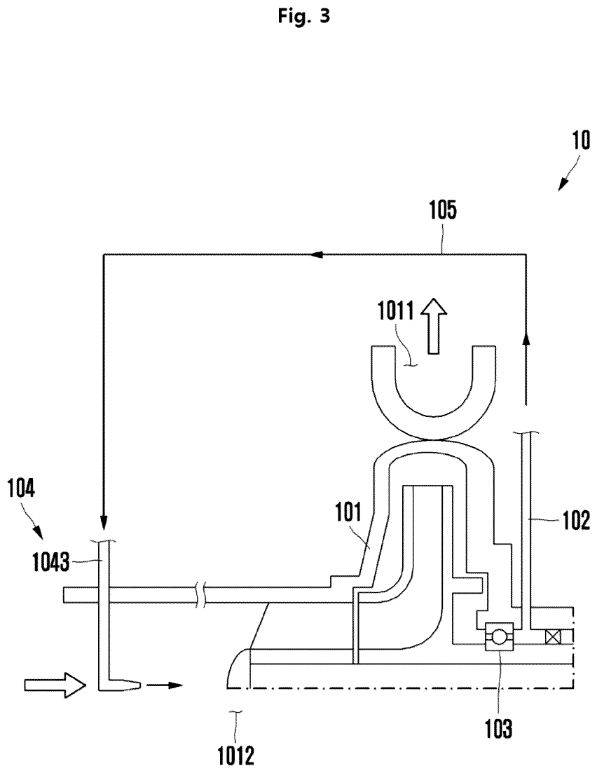

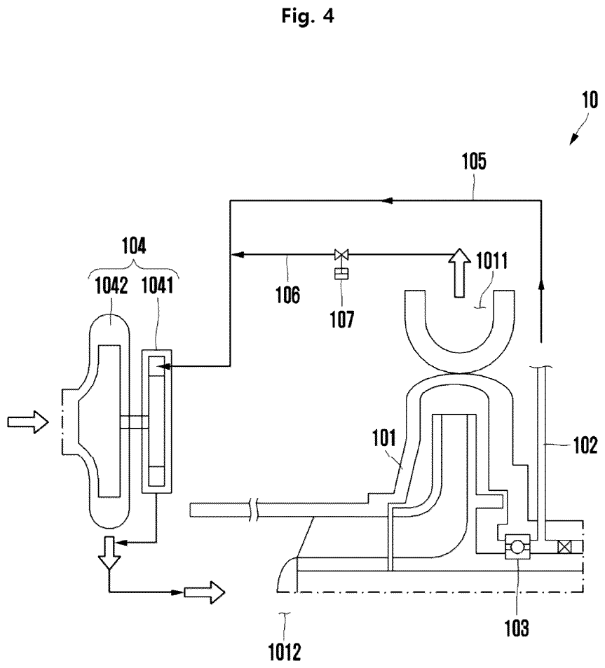

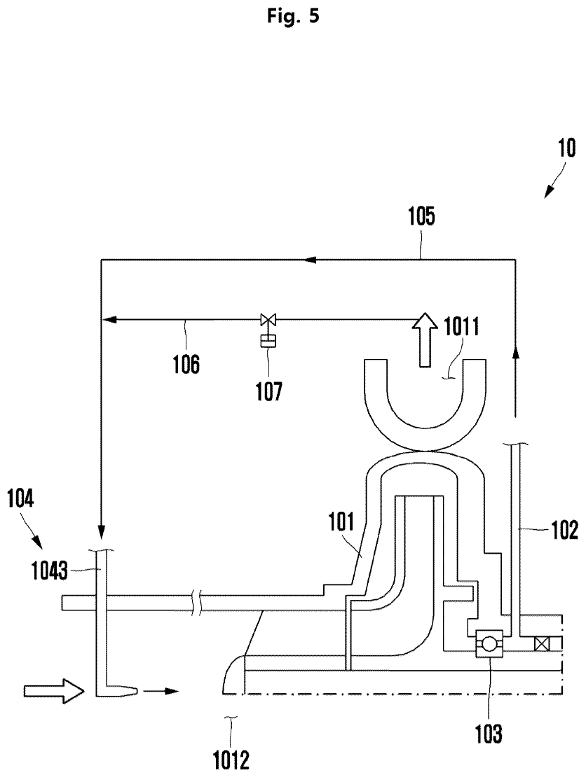

FIG. 1 schematically illustrates a turbo pump system 10 according to an embodiment, FIG. 2 schematically illustrates the turbo pump system 10 according to the embodiment that includes a booster 104 including a turbine 1041 and a turbine pump 1042, FIG. 3 schematically illustrates the turbo pump system 10 according to the embodiment that includes the booster 104 including a nozzle 1043, FIG. 4 schematically illustrates the turbo pump system 10 according to the embodiment in FIG. 2 that has a second flow path 106, and FIG. 5 schematically illustrates the turbo pump system 10 according to the embodiment in FIG. 3 that has the second flow path 106.

With reference to FIG. 1, the turbo pump system 10 according to the embodiment may include a main pump 101, a branch pipe 102, and the booster 104.

The main pump 101 may have a discharge port 1011 and a suction port 1012. A fluid may enter and exit the main pump 101 through the discharge port and the suction port 1012. The main pump 101 may suck the fluid through the suction port 1012, pump the fluid under high pressure, and transfer the fluid through the discharge port 1011.

The branch pipe 102 may discharge a part of the fluid, which is introduced from the suction port 1012, through an outlet provided separately from the discharge port 1011. For example, one end of the branch pipe 102 may communicate with the suction port 1012, and the other end of the branch pipe 102 may extend while defining a route provided separately from a route along which a main flow path formed from the suction port 1012 to the discharge port 1011 is formed.

The booster 104 may be disposed at an upstream side of the suction port 1012. The booster 104 may have an outlet communicating with the suction port 1012 and raise pressure in the suction port 1012. The fluid discharged through the branch pipe 102 may be introduced into the booster 104. The fluid, which is introduced into the booster 104 from the branch pipe 102, may operate the booster 104 and then be discharged to the outlet of the booster 104, and the fluid may move to the suction port 1012 of the main pump 101. That is, the fluid discharged through the branch pipe 102 may be used to allow the booster 104 to raise the pressure in the suction port 1012 of the main pump 101.

The turbo pump system 10 according to the embodiment may be used to transfer high-pressure liquids or gases in various fields, such as rocket engines, firefighting or industrial high-pressure pumps, and pumps for ships such as LNG pumps for LNG carriers. Hereinafter, the turbo pump system 10 used for the rocket engine will be described as an example.

In this case, the turbo pump system 10 according to the embodiment may further include a bearing 103. For example, the bearing 103 may correspond to a shaft of an impeller that transfers any one of a liquid oxidant or fuel in an rocket engine that uses a liquid propellant. In this case, the turbo pump system 10 may cool the bearing 103. During this process, a part of the fluid discharged from the main pump 101 may cool the bearing 103 and effectively remove heat generated by a high-speed rotation of the shaft. The fluid, which has been used to cool the bearing 103, may still remain in a high pressure state even after the bearing 103 is cooled. Therefore, the turbo pump system 10 according to the embodiment may cool the bearing 103 by using a part of the fluid discharged through the branch pipe 102 and then supply the fluid to the booster 104, as described above, such that the used fluid may be reused.

The bearing 103 may be disposed between the main pump 101 and the booster 104. Specifically, the bearing 103 may be disposed on the branch pipe 102. Therefore, the fluid flowing through the branch pipe 102 may pass through the bearing 103. A part of the fluid discharged from the main flow path to the branch pipe 102 may cool the bearing 103 while passing through the bearing 103. The fluid may enter and exit the discharge port 1011 and the suction port 1012 of the main pump 101, and a part of the fluid discharged to the branch pipe 102 may be defined as a cooling fluid. The cooling fluid may cool the bearing 103 and then be introduced into the booster 104.

In the turbo pump system 10 according to the embodiment described above, a part of the fluid may be discharged to a separate outlet through the branch pipe 102 to cool the bearing 103 during a process in which the main pump 101 sucks the fluid through the suction port 1012 and transfers the fluid to the discharge port 1011 under high pressure. The cooling fluid discharged through the branch pipe 102 may be reused to operate the booster 104 without being merely discharged and consumed only to cool the bearing 103. Because the energy generated by the main pump 101 is reused by the booster 104 as described above, it is possible to reduce energy wasted in the turbo pump system 10 and improve the performance of the turbo pump system 10.

With reference to FIG. 2, the booster 104 of the turbo pump system 10 according to the embodiment may include the turbine 1041 and the turbine pump 1042.

The turbine 1041 may be in fluid communication with the branch pipe 102. That is, cooling fluid may cool the bearing 103 and then be introduced into the turbine 1041 to operate the turbine 1041.

The turbine pump 1042 may be connected to the turbine 1041. The turbine pump 1042 may be rotated by the turbine 1041. The turbine pump 1042 may have a discharge port and a suction port through which the fluid enters and exits. The cooling fluid, which has operated the turbine 1041, may be merged into the cooling fluid discharged from the discharge port of the turbine pump 1042. The cooling fluid may rotate the turbine pump 1042 by operating the turbine 1041 and then raise the pressure of the fluid passing through the booster 104. The discharge port of the turbine pump 1042 may be in fluid communication with the suction port 1012 of the main pump 101. Therefore, the cooling fluid with the raised pressure may be introduced back into the main pump 101 through the suction port 1012 of the main pump 101. The cooling fluid, which maintains high pressure even after the bearing 103 is cooled, is supplied to the suction port 1012 via the booster 104, such that the overall pressure of the fluid introduced from the suction port 1012 may be raised, thereby improving the suction performance of the main pump 101. As a result, the turbo pump system 10 may more efficiently use energy.

With reference to FIGS. 1 and 2, the turbo pump system 10 according to the embodiment may further include a first flow path 105.

The first flow path 105 may connect the branch pipe 102 and the booster 104 and guide the cooling fluid so that the cooling fluid passes through the bearing 103 and then be introduced into the booster 104.

Specifically, the cooling fluid may be used to cool the bearing 103 while passing through the branch pipe 102 and then moved to the booster 104 through the first flow path 105.

The first flow path 105 may allow the branch pipe 102 and the booster 104 to be in fluid communication with each other. Therefore, the cooling fluid discharged through the branch pipe 102 may be introduced into the booster 104 along the first flow path 105. For example, in case that the booster 104 includes the turbine 1041 and the turbine pump 1042, as illustrated in FIG. 2, the first flow path 105 may connect the turbine 1041 of the booster 104 and the branch pipe 102. Therefore, after the cooling fluid cools the bearing 103, the cooling fluid may be discharged from the branch pipe 102 and transferred to the turbine 1041 along the first flow path 105.

With reference to FIG. 3, the booster 104 of the turbo pump system 10 according to the embodiment may include the nozzle 1043.

An injection port of the nozzle 1043 may be disposed toward the suction port 1012 of the main pump 101. The nozzle 1043 may inject the fluid into the suction port 1012 of the main pump 101 to raise the pressure in the suction port 1012. In addition, an inlet of the nozzle 1043 may be in fluid communication with the branch pipe 102. That is, the cooling fluid may cool the bearing 103 and be introduced into the nozzle 1043, and then the cooling fluid may be injected into the suction port 1012 of the main pump 101. Therefore, the cooling fluid with the raised pressure may be introduced back into the main pump 101 through the suction port 1012 of the main pump 101. The cooling fluid, which maintains high pressure even after the bearing 103 is cooled, may be injected under high pressure into the suction port 1012 via the booster 104, such that the pressure of the fluid in the suction port 1012 may be raised, thereby improving the performance of the main pump 101.

With reference to FIGS. 1 and 3, in case that the booster 104 includes the nozzle 1043, the first flow path 105 may connect the branch pipe 102 and the nozzle 1043.

Specifically, after the cooling fluid is used to cool the bearing 103 while passing through the branch pipe 102, the cooling fluid may move to the booster 104 through the first flow path 105.

The first flow path 105 may allow the branch pipe 102 and the booster 104 to be in fluid communication with each other. Therefore, the cooling fluid discharged through the branch pipe 102 may be introduced into the booster 104 along the first flow path 105. For example, the first flow path 105 may allow the branch pipe 102 and the nozzle 1043 to be in fluid communication with each other. Therefore, after the cooling fluid cools the bearing 103, the cooling fluid may be discharged from the branch pipe 102 and moved to the booster 104 along the first flow path 105, and then the cooling fluid may be injected into the suction port 1012 of the main pump 101 through the nozzle 1043.

With reference to FIGS. 4 and 5, the turbo pump system 10 according to the embodiment may further include the second flow path 106.

The second flow path 106 may connect the discharge port 1011 of the main pump 101 and the booster 104.

Specifically, one end of the second flow path 106 may be connected to the discharge port 1011, and the other end of the second flow path 106 may be connected to the booster 104, such that the discharge port 1011 and the booster 104 may be in fluid communication with each other. The second flow path 106 may additionally supply the fluid to the booster 104 through a route provided separately from the first flow path 105. In addition, the second flow path 106 may selectively supply the fluid to the booster 104.

The turbo pump system 10 according to the embodiment may further include a valve 107.

The valve 107 may be installed in the second flow path 106. The valve 107 may switch to a first mode or a second mode. The valve 107 may control a flow of the fluid flowing through the second flow path 106. That is, the valve 107 may selectively allow the flow of the fluid flowing through the second flow path 106.

For example, the valve 107 may be opened when the valve 107 is in the first mode, and the valve 107 may be closed when the valve 107 is in the second mode. When the valve 107 switches to the first mode, the flow of the fluid flowing through the second flow path 106 may be allowed. In addition, when the valve 107 switches to the second mode, the flow of the fluid through the second flow path 106 may be interrupted.

With reference to FIG. 4, in the turbo pump system 10 according to the embodiment in which the booster 104 includes the turbine 1041 and the turbine pump 1042, the second flow path 106 may connect the discharge port 1011 of the main pump 101 and the turbine 1041.

Specifically, one end of the second flow path 106 may be connected to the discharge port 1011, and the other end of the second flow path 106 may be connected to an inlet of the turbine 1041, such that the discharge port 1011 and the turbine 1041 may be in fluid communication with each other. The second flow path 106 may additionally supply the fluid directly to the turbine 1041 from the main pump 101 independently of the first flow path 105 that supplies the cooling fluid to the turbine 1041. In addition, the valve 107, which may switch to the first mode or the second mode, may be installed in the second flow path 106, and the valve 107 may control the flow of the fluid flowing through the second flow path 106. That is, the valve 107 may selectively allow the flow of the fluid to be supplied to the turbine 1041 from the main pump 101 through the second flow path 106.

For example, when the valve 107 switches to the first mode, the supply of the fluid from the main pump 101 to the turbine 1041 may be allowed. In addition, when the valve 107 switches to the second mode, the supply of the fluid from the main pump 101 to the turbine 1041 may be interrupted.

With reference to FIG. 5, in the turbo pump system 10 according to the embodiment in which the booster 104 includes the nozzle 1043, the second flow path 106 may connect the discharge port 1011 of the main pump 101 and the nozzle 1043.

Specifically, one end of the second flow path 106 may be connected to the discharge port 1011, and the other end of the second flow path 106 may be connected to the inlet of the nozzle 1043, such that the discharge port 1011 may be in fluid communication with the injection port of the nozzle 1043. The second flow path 106 may additionally supply the fluid directly to the nozzle 1043 from the main pump 101 independently of the first flow path 105 that supplies the cooling fluid to the nozzle 1043. In addition, the valve 107, which may switch to the first mode or the second mode, may be installed in the second flow path 106, and the valve 107 may control the flow of the fluid flowing through the second flow path 106. That is, the valve 107 may selectively allow the flow of the fluid to be supplied to the nozzle 1043 from the main pump 101 through the second flow path 106.

For example, when the valve 107 switches to the first mode, the supply of the fluid from the main pump 101 to the nozzle 1043 may be allowed. In addition, when the valve 107 switches to the second mode, the supply of the fluid from the main pump 101 to the nozzle 1043 may be interrupted.

With reference back to FIG. 1, the turbo pump system 10 according to the embodiment may further include a controller 108.

The controller 108 may control the valve 107. The controller 108 may switch the valve 107 to the first mode or the second mode. For example, the controller 108 may be connected to the valve 107 in a wired or wireless manner. For example, the controller 108 may remotely switch the valve to the first mode or the second mode.

The turbo pump system 10 according to the embodiment may further include a fluid supplier and a sensor.

The fluid supplier may supply the fluid to the suction port of the turbine pump 1042. The fluid supplier may include therein a fluid supply tank configured to store the fluid, and a supply flow path configured to allow the fluid supply tank and the suction port of the turbine pump 1042 to communicate with each other.

The sensor may measure a value of internal pressure of the fluid supplier. The value of the internal pressure measured by the sensor may be inputted to the controller 108. The controller 108 may control the valve 107 based on the value of the internal pressure of the fluid supplier. A reference pressure value may be inputted to the controller 108 in advance.

The controller 108 may compare the value of the internal pressure of the fluid supplier with the reference pressure value and control an operation of opening or closing the valve 107. For example, in case that the value of the internal pressure of the fluid supplier is smaller than the reference pressure value, the controller 108 may switch the valve 107 to the first mode from the second mode.

According to the turbo pump system 10 according to the embodiment, it is possible to reduce energy waste and improve the performance of the turbo pump system 10 by efficiently reusing the fluid that still maintains high pressure even after the bearing 103 is cooled.

According to the turbo pump system 10 according to the embodiment, it is possible to maximally and efficiently utilize the fluid by introducing the fluid, which has passed through the bearing 103, into the booster 104, operating the booster 104, and then guiding the fluid back into the suction port 1012 of the main pump 101.

The turbo pump system 10 according to the embodiment may utilize the cooling fluid that has been used to cool the bearing 103, thereby additionally increasing the pressure in the suction port 1012 of the main pump 101 and reducing the occurrence of cavitation.

The turbo pump system 10 according to the embodiment may reuse the cooling fluid used to cool the bearing 103, thereby improving the performance of the turbo pump system 10 relative to the thickness of the same fluid tank.

While the embodiments of the present disclosure have been described above with reference to particular contents such as specific constituent elements, the limited embodiments, and the drawings, but the embodiments are provided merely for the purpose of helping understand the present disclosure overall, and the present disclosure is not limited to the embodiment, and may be variously modified and altered from the disclosure by those skilled in the art to which the present disclosure pertains. For example, appropriate results may be achieved even though the described technologies are performed in different order from the described method, the described constituent elements such as, the structures, the apparatuses, and the like are coupled or combined in different manners from the described method, and/or the constituent elements are substituted with or replaced by other constituent elements or equivalents. Accordingly, the spirit of the present disclosure should not be limited to the described embodiment, and all of the equivalents or equivalent modifications of the claims as well as the appended claims belong to the scope of the spirit of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A turbo pump system comprising:
a main pump having a discharge port and a suction port through which a fluid enters and exits;
a branch pipe configured to discharge a part of the fluid, which is introduced from the suction port, through an outlet provided separately from the discharge port; and
a booster disposed at an upstream side of the suction port and having an outlet communicating with the suction port, the booster being configured to raise pressure in the suction port,
wherein the fluid discharged through the branch pipe is introduced into the booster, operates the booster, and then moves to the suction port of the main pump.

2. The turbo pump system of claim 1, further comprising:
a bearing disposed between the main pump and the booster,
wherein the fluid moving through the branch pipe cools the bearing while passing through the bearing and then is introduced into the booster.

3. The turbo pump system of claim 1, wherein the booster comprises:
a turbine; and
a turbine pump connected to the turbine, and
wherein the fluid operates the turbine, rotates the turbine pump, and then raises pressure of the fluid passing through the booster.

4. The turbo pump system of claim 1, wherein the booster comprises a nozzle having an injection port disposed toward the suction port, and the nozzle injects the fluid into the suction port to raise the pressure in the suction port.

5. The turbo pump system of claim 2, further comprising:
a first flow path configured to connect the branch pipe and the booster,
wherein the fluid, which has been used to cool the bearing, is supplied to the booster through the first flow path.

6. The turbo pump system of claim 5, further comprising:
a second flow path configured to connect the discharge port of the main pump and the booster,
wherein the second flow path additionally supplies the fluid to the booster independently of the first flow path.

7. The turbo pump system of claim 6, further comprising:
a valve installed in the second flow path and configured to switch to a first mode or a second mode,
wherein the valve selectively allows a flow of the fluid flowing through the second flow path.

8. The turbo pump system of claim 7, wherein a movement of the fluid through the second flow path is allowed when the valve switches to the first mode, and a movement of the fluid through the second flow path is interrupted when the valve switches to the second mode.

9. The turbo pump system of claim 8, further comprising:
a controller configured to control the valve,
wherein the controller remotely switches the valve to the first mode or the second mode.

10. The turbo pump system of claim 9, wherein the booster comprises:
a turbine; and
a turbine pump connected to the turbine,
wherein the booster further comprises:
a fluid supplier configured to store the fluid therein and supply the fluid to the turbine pump; and
a sensor configured to measure a value of internal pressure of the fluid supplier, and
wherein the controller compares a reference pressure value, which is inputted in advance, and the value of the internal pressure of the fluid supplier and controls the valve.

11. The turbo pump system of claim 10, wherein the controller controls the valve to switch the valve to the first mode when the value of the internal pressure of the fluid supplier is smaller than the reference pressure value.
